(19) United States
(12) Patent Application Publication
(10) Pub. No.: US 2023/0122150 A1
(43) Pub. Date: Apr. 20, 2023

(54) EXPLAINABILITY OF TIME SERIES PREDICTIONS MADE USING STATISTICAL MODELS

(71) Applicant: Oracle International Corporation, Redwood Shores, CA (US)

(72) Inventors: Nitin Rawat, New Delhi (IN); Lakshmi Sirisha Chodisetty, Bangalore (IN); Samik Raychaudhuri, Bangalore (IN); Vijayalakshmi Krishnamurthy, Sunnyvale, CA (US)

(73) Assignee: Oracle International Corporation, Redwood Shores, CA (US)

(21) Appl. No.: 17/731,147

(22) Filed: Apr. 27, 2022

Related U.S. Application Data
(60) Provisional application No. 63/253,505, filed on Oct. 7, 2021.

(51) Int. Cl. G06N 7/00; G06K 9/62

(52) U.S. Cl. CPC G06N 7/005; G06K 9/6296

(57) ABSTRACT

Techniques are described for providing explanation information for time series-based predictions made using statistical models, such as linear statistical models, examples of which include various Exponential Smoothing models, Autoregressive Integrated Moving Average (ARIMA) models, and others. For a forecast predicted by a statistical model that has been trained upon and/or fit to a set of historical times series data points, an explanation is generated for the forecast, where the explanation for the forecast includes information indicative of the importance or impact or influence of individual time series data points in the set on the forecast. The explanation for the forecast may be output to a user along with the forecast. This enables the user to have some visibility into why the particular forecast was predicted by the statistical model.

### CROSS-REFERENCE TO RELATED APPLICATIONS

The present application is a non-provisional application of and claims the benefit and priority under 35 U.S.C. 119(e) of U.S. Provisional Application No. 63/253,505, filed Oct. 7, 2021, entitled “Explainability of Time-Series Predictions made using Statistical Models,” the entire contents of which are incorporated herein by reference for all purposes.

### BACKGROUND

A time series or time series dataset is a sequence of data points, measured typically at successive times over a time interval. Examples of time series data include: a set of temperature values captured every day over several days, the price of a stock observed every 5 minutes, monthly sales for a corporation captured over several months, and the like. Time series forecasting refers to a set of forecasting techniques that, given a time series, uses one or more models to forecast an event or observation for a time point in the future. Time series forecasting is used in various fields such as for making economic forecasts, stock market forecasts, product sales forecasts, and so on. The models that are used for analyzing the time series data and for making the forecasts may include, for instance, machine learning models, statistical models and the like. Typically, when a model (e.g., a machine learning model or a statistical model) is used for time series forecasting, an appropriate model has to be first selected based upon the time series data to be used for the forecasting. The model then has to be trained and validated using the time series data, and after the model has reached an acceptable level of accuracy, the model is then used for forecasting for a future time point.

The ability to correctly explain and interpret the prediction of a model is as important as the accuracy of the model itself. Recently various methods like LIME, DeepLIFT, LRP, Shapley values, Saliency methods and the like have been proposed to help users interpret the output of predictions of complex machine learning models such as deep learning models, tree based models, and ensemble models. While some of these methods are being adopted in time series forecasting, they are limited to only certain types of models. For example, these methods are not applicable to linear statistical models such as Exponential Smoothing models, Autoregressive Integrated Moving Average (ARIMA) models, and the like which are very powerful, especially when dealing with smaller amounts of data.

Attempts towards explaining the outputs (predictions) from traditional statistical models thus remains relatively unexplored. Additionally, explaining the predictions made using these models has to be done manually and the methodology can become complicated. As a result, in most cases, this cannot be done manually, and typically requires a whole lot of compute resources and time. There is thus a need for developing efficient techniques for explaining time series-based predictions made using statistical models.

### BRIEF SUMMARY

The present disclosure relates to predictions made using statistical models, and more particularly, to techniques for providing an explanation for time series-based predictions made using statistical models, such as linear statistical models, examples of which include various Exponential Smoothing models, Autoregressive Integrated Moving Average (ARIMA) models, and others. Various embodiments are described herein, including methods, systems, non-transitory computer-readable storage media storing programs, code, or instructions executable by one or more processors, and the like.

In certain embodiments, for a forecast predicted by a statistical model that has been trained upon and/or fit to a set of historical times series data points, an explanation is generated for the forecast, where the explanation for the forecast includes information indicative of the importance or impact or influence of individual time series data points in the set on the forecast. The explanation for the forecast may be output to a user along with the forecast. This enables the user to have some visibility into why the particular forecast was predicted by the statistical model.

In certain embodiments, techniques are described for generating explanation information for a forecast predicted using a model. The technique includes receiving a time series forecast request requesting a forecast for a particular time point. The request identifies a time series dataset to be used for the requested forecast and the time series dataset comprises a set of data points. Each data point in the time series dataset has an actual value and an associated time value. The technique includes training the model using the time series dataset to generate a trained model and using the trained model to generate an actual forecast for the particular time point.

Responsive to the actual forecast predicted for the particular time point using the trained model, for each data point in one or more data points in the time series dataset, the technique then includes perturbing the actual value of a data point by a certain amount to generate a permuted value for the data point. The technique includes using the trained model to predict a permuted prediction for the particular time point based on the permuted value for the data point and the actual values for the other data points in the times series dataset other than the data point. The technique further includes generating explanation information for the data point based on the permuted prediction for the particular time point, the actual forecast, the permuted value for the data point and the actual value of the data point.

The technique then includes generating explanation information for the time series dataset, where the explanation information includes the explanation information generated for the one or more data points in the time series dataset and outputting the actual forecast and the explanation information for the time series dataset. In certain examples, the explanation information for the time series dataset is indicative of an impact of the actual value of the one or more data points on the actual forecast. The actual forecast and the explanation information for the time series dataset is then output to a user associated with a source.

In certain examples, the time series dataset is received from a forecast request from the source and outputting the actual forecast and the explanation information for the time series dataset comprises communicating the actual forecast and the explanation information for the time series dataset to the source.

In certain examples, generating the explanation information for the time series dataset comprises computing a feature forecast weight for the data point based upon the permuted prediction for the particular time point, the actual forecast, the permuted value for the data point and the actual value of the data point. Generating the explanation information further includes computing a forecast feature importance value for the data point using the feature forecast weight computed for the data point.

In certain examples, the feature forecast weight for the data point is computed as a ratio of the difference between the permuted prediction and the actual prediction to the difference between the permuted value for the data point and the actual value of the data point.

In certain examples, the forecast feature importance value for the data point is computed as a product of a first term and a second term. The first term comprises the feature forecast weight computed for the data point and the second term is computed by computing a difference between the actual value of the data point and the mean of the one or more data points in the time series dataset.

In certain examples, outputting the actual forecast and the explanation information for the time series dataset to the source comprises outputting a bar graph to a user of the source. In certain examples, the actual forecast along with the forecast feature importance value computed for the data point is output to a user of the source. In certain examples, the explanation information for the time series dataset is represented as a visualization comprising a bar graph where the bar graph represents the impact of the actual value of the one or more data points on the actual forecast. In certain examples, the model is a statistical model comprising at least one of an exponential smoothing model or an Autoregressive Integrated Moving Average (ARIMA) model.

The foregoing, together with other features and embodiments will become more apparent upon referring to the following specification, claims, and accompanying drawings.

### BRIEF DESCRIPTION OF THE DRAWINGS

FIG. 1 depicts a computing environment that includes a time series forecasting service system that includes capabilities for generating explanation information for a forecast predicted using a statistical model, according to certain embodiments.

FIG. 2 depicts an example of a process by which the time series forecasting service system 120 shown in FIG. 1 generates explanation information for a time series forecast predicted using a statistical model, according to certain embodiments.

FIG. 3 depicts an example of a process by which the time series forecasting service system 120 shown in FIG. 1 generates explanation information for a data point, according to certain embodiments.

FIG. 4 is an exemplary illustration of the representation of explanation information for a time series dataset, according to certain embodiments.

FIG. 5 depicts an example of a forecast generated using a Holt’s Linear Trend statistical model for a time series dataset, according to certain embodiments.

FIG. 6 depicts the expansion representation form of the Holt’s Linear Trend method, according to certain embodiments.

FIG. 7 illustrates a visual representation of the forecast feature importance values computed using a triple exponential smoothing model for a future time point based on a time series dataset, according to certain embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to predictions made using statistical models, and more particularly, to techniques for providing an explanation for time series-based predictions made using statistical models, such as linear statistical models, examples of which include various Exponential Smoothing models, Autoregressive Integrated Moving Average (ARIMA) models, and others. In certain embodiments, for a forecast predicted by a statistical model that has been trained upon and/or fit to a set of historical times series data points, an explanation is generated for the forecast, where the explanation for the forecast includes information indicative of the importance or impact or influence of individual time series data points in the time series dataset on the forecast. The explanation for the forecast may be output to a user along with the forecast. This enables the user to have some visibility into why the particular forecast was predicted by the statistical model.

As previously described, attempts towards explaining the outputs of traditional statistical models remain relatively unexplored because explaining the predictions made using these models is generally done manually. Thus, explaining the output from these models is a time consuming and computationally intensive task. For example, traditional statistical models like Exponential Smoothing models and ARIMA models have a well-established theoretical foundation but explaining the output from these models is a challenging task. Although some of the simple statistical methods like simple exponential smoothing, moving average, etc. are easier to understand and interpret, models like the Holt-Winters method and ARIMA are complex and interpreting the prediction from these models is not a trivial task.

The novel and innovative techniques described in this disclosure enable a forecast predicted by a statistical model to be explained. The techniques described herein can be used to explain the predictions from any linear statistical model, from simple models, such as Simple Moving Average models, Simple Exponential Smoothing models, to more complex models, such as Double/Triple Exponential Smoothing models, ARIMA models, and others. The techniques described in this disclosure are not dependent on the specific linear statistical model being used. This enables the same technique to be applied to multiple linear statistical models, thereby simplifying the generation of the explanations.

In certain embodiments, for a forecast predicted by a statistical model that has been trained upon and/or fit to a set of historical times series data points, an explanation is generated for the forecast, where the explanation for the forecast includes information indicative of the importance or impact or influence of individual time series data points in the time series dataset on the forecast. For instance, the output of a statistical model for a point forecast at time t can be explained in terms of the important past/historical values of the time series dataset (from t-1 until 1, the beginning of the time series). These past values are also referred to herein as lagged variables or lagged features. The information indicative of the importance of the lag features can be presented or output in various forms, including different graphical or visual forms. This enables the user to have some visibility into why the particular forecast was predicted by the statistical model. Explainability inspires confidence in a model because it provides an indication as to why a certain value was forecast by the model. This is key in increasing a user’s level of confidence in the predicted value. This in turn plays an important role in the widespread adoption of forecasts made using statistical models.

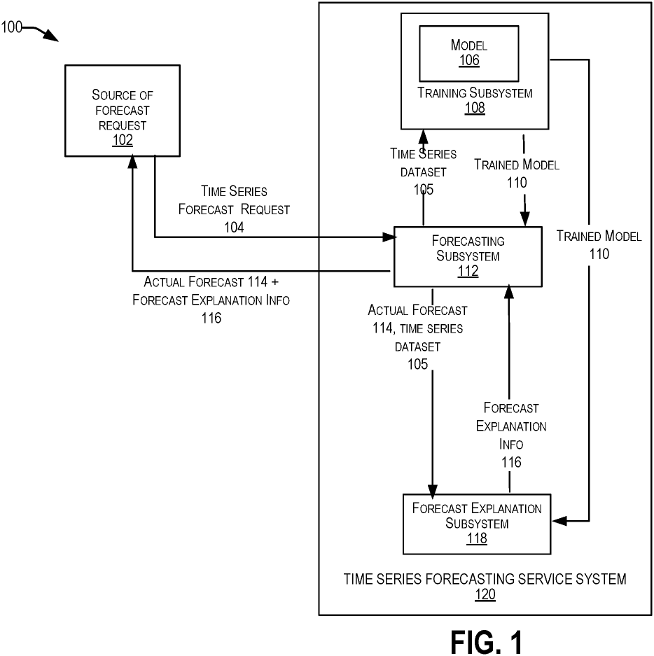

Referring now to the drawings, FIG. 1 depicts a computing environment that includes a time series forecasting service system 120 that includes capabilities for generating explanation information for a forecast predicted using a statistical model, according to certain embodiments. The time series forecasting service system 120 may be implemented by one or more computing systems that execute computer-readable instructions (e.g., code, program) to implement the time series forecasting service system 120. As depicted in FIG. 1, the time series forecasting service system 120 includes various systems and subsystems including a training subsystem 108, a forecasting subsystem 112 and a forecast explanation subsystem 118. The systems and subsystems depicted in FIG. 1 may be implemented using software (e.g., code, instructions, program) executed by one or more processing units (e.g., processors, cores) of a computing system, hardware, or combinations thereof. The software may be stored on a non-transitory storage medium (e.g., on a memory device).

The time series forecasting service system 120 may be implemented in various different configurations. In certain embodiments, the time series forecasting service system 120 may be implemented on one or more servers of a cloud provider network and its forecast explanation services may be provided to subscribers of cloud services on a subscription basis. Computing environment 100 depicted in FIG. 1 is merely an example and is not intended to unduly limit the scope of claimed embodiments. One of ordinary skill in the art would recognize many possible variations, alternatives, and modifications. For example, in some implementations, the time series forecasting service system 120 can be implemented using more or fewer subsystems than those shown in FIG. 1, may combine two or more subsystems, or may have a different configuration or arrangement of subsystems.

In certain embodiments, the time series forecasting service system 120 provides a fast and reliable service for explaining time series forecasts or predictions made using statistical models. As depicted in FIG. 1, a time series forecast request (e.g., 104) may be received from a source 102 that is communicatively coupled to the time series forecasting service system 120 possibly via a communication network (e.g., the Internet). The source 102 may represent a user device of an entity such as a customer (e.g., an organization, an enterprise, or an individual) who subscribes to the services provided by the time series forecasting service system 120. The user device may be of various types, including but not limited to, a mobile phone, a tablet, a desktop computer, and the like. A user (e.g., a consumer or requestor of the forecast request) of the entity may interact with the time series forecasting service system 120 using a browser executed by the user device. For example, the user may use a user interface (UI) (which may be a graphical user interface (GUI)) of the browser executed by the user device to interact with the time series forecasting service system 110. In other examples, the source 102 may also represent an external service that can automatically generate a time series forecast request 104 for an entity such as a customer (e.g., an organization, an enterprise, or an individual) who subscribes to the services provided by the time series forecasting service system 120.

In certain examples, the time series forecast request 104 identifies historical time series data (also referred to herein as a time series dataset) that is to be used as the basis to generate a requested forecast for a particular future time point (T). A time series dataset comprises a sequence of data points recorded in time order. Each data point (also referred to herein as a lagged data point) in the time series dataset comprises a value (e.g., an observed value) and an associated time value that is less than the forecast time point T.

In certain embodiments, the forecasting subsystem 112 receives the forecast request 104 and provides a time series dataset 105 that is received as part of the forecast request 104 to the training subsystem 108. The training subsystem 108 selects a model (e.g., 106) to be used for generating the requested forecast. The model 106 may represent a linear statistical model, such as a Simple Moving Average model, a Simple Exponential Smoothing model, or may represent more complex models, such as a Double/Triple Exponential Smoothing model, an ARIMA model, and so on. The training subsystem 108 trains the selected model using the time series dataset 105 to generate a trained model 110 and provides the trained model 110 to the forecasting subsystem 112. The forecasting subsystem 112 uses the trained model and the time series dataset 105 to generate an actual forecast (also referred to herein as an actual prediction) 114 for the time point T.

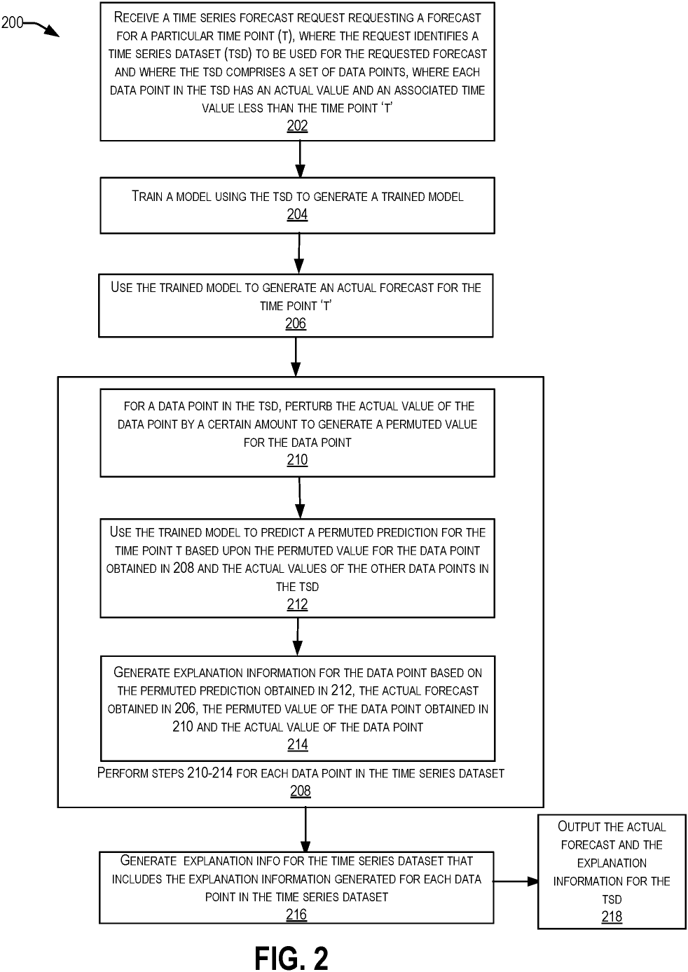

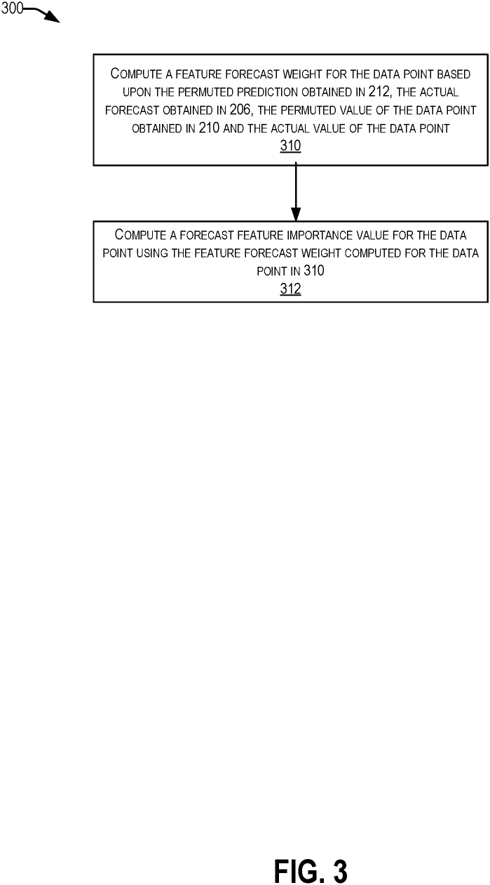

The forecasting subsystem 112 then provides the actual forecast 114 predicted using the trained model 110 and the time series dataset 105 to the forecast explanation subsystem 118. The forecast explanation subsystem 118 performs processing to generate forecast explanation information 116 for the actual forecast 114. The forecast explanation information 116 comprises information indicative of an impact of the set of data points in the time series dataset on the actual forecast. In certain examples, and as will be described in detail below, the explanation information 116 for the forecast is generated by applying a perturbation technique to the data points in the time series dataset. The forecast explanation subsystem 118 then provides the forecast explanation information 116 to the forecasting subsystem 112. The forecasting subsystem 112 provides the actual forecast 114 along with the forecast explanation information 116 to a user of the source 102 as a response to the received request 104. Additional details of the processing performed by the systems and subsystems depicted in FIG. 1 to generate explanation information for a forecast is described below with respect to the flowcharts in FIG. 2 and FIG. 3 and their accompanying description.

FIG. 2 depicts an example of a process 200 by which the time series forecasting service system 120 shown in FIG. 1 generates explanation information for a time series forecast predicted using a statistical model, according to certain embodiments. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 200 presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in FIG. 2 may be performed by the training subsystem 108, the forecasting subsystem 112 and the forecast explanation subsystem 118 in the time series forecasting service system 120.

The processing depicted in FIG. 2 may be initiated when, at block 202, a time series forecast request (e.g., 104) requesting a forecast for a particular time point T is received for processing by the forecasting subsystem 112. For example, the forecasting subsystem 112 may receive the time series forecast request 104 from a source 102 as described in FIG. 1. As previously described, the time series forecast request 104 identifies a time series dataset (e.g., 105) to be used for the requested forecast. The time series dataset comprises a set of data points, where each data point in the time series dataset has an actual value and an associated time value less than the forecast time T.

At block 204, the forecasting subsystem 112 provides the time series dataset 105 that is received as part of the forecast request 104 to the training subsystem 108. The training subsystem 108 selects a model (e.g., 106) to be used for generating the requested forecast. As previously described, the model 106 may represent a linear statistical model, such as a Simple Moving Average model, a Simple Exponential Smoothing model, or may represent more complex models, such as a Double/Triple Exponential Smoothing model, an ARIMA model, and so on. The training subsystem 108 then trains the selected model using the time series dataset to generate a trained model 110 and provides the trained model 110 to the forecasting subsystem 112.

At block 206, the forecasting subsystem 112 uses the trained model and the time series dataset to generate an actual forecast (e.g., 114) for the time point T. By way of example, for a time series dataset that comprises a set of data points [y₀, y₁, y₂, ... , yₜ₋₁], the trained model is trained or fit to the historical dataset (y₀ till yₜ₋₁) by the training subsystem 108 and the forecasting subsystem 112 uses the trained model to predict an actual forecast (ŷₜ) for the time point T. The forecasting subsystem 112 then provides the actual forecast 114 and the time series dataset 105 that is received as part of the forecast request 104 to the forecast explanation subsystem 118.

At block 208, the forecast explanation subsystem 118 performs the processing described in blocks 210-214 for each data point in the time series dataset to generate explanation information for the data points. The explanation information comprises information indicative of an impact of the data point in the time series dataset on the actual forecast 114.

For instance, as part of the processing performed to generate the explanation information, at block 210, the forecast explanation subsystem 118 determines an actual value (also referred to herein as an actual lagged value (ALV)) for the data point and perturbs the actual value of the data point by a certain amount to generate a permuted value (also referred to herein as a “Permuted Lagged Value” (PLV)) for the data point. The “certain amount” can be any value and may be pre-determined by an administrator of the system 120. In certain implementations, a value of -1 or + 1 is used.

At block 212, the forecast explanation subsystem 118 uses the trained model to predict a permuted prediction for the time point T based upon the permuted value for the data point obtained in 210 and the actual values of the other data points in the time series dataset. In other words, while keeping the ALVs of other data points in the time series dataset the same as in the time series dataset, and using the permuted value generated in block 210 for the data point, the forecast explanation subsystem 118 uses the trained model, which was used to generate the actual forecast in block 206 to generate a “Permuted Prediction” (PP) for time “T.” For instance, using the example of the set of data points [y₀, y₁, y₂, ... , yₜ₋₁] described above, the forecast explanation subsystem 118 may perturb an actual value of a data point yₜ₋₁ and generate a permuted prediction (also referred to herein as a perturbed prediction) for ŷₜ for this perturbation by keeping all other lagged variables (y₀ till yₜ₋₂) constant.

At block 214, the forecast explanation subsystem 118 generates explanation information for the data point based on the permuted prediction obtained in block 212, the actual forecast obtained in block 206, the permuted value of the data point obtained in block 210 and the actual value of the data point. Additional details of the processing performed by the forecast explanation subsystem 118 to generate explanation information for the data point is described below with respect to the flowchart in FIG. 3 and its accompanying description.

As described in relation to FIG. 2, in certain embodiments, the forecast explanation subsystem 118 performs the processing described in blocks 210-214 for each data point in the time series dataset to generate explanation information for the data point, where the explanation information comprises information indicative of an impact of the data point in the time series dataset on the actual forecast 114. For instance, based on the example of the set of data points [y₀, y₁, y₂, ... , yₜ₋₁] described above, the forecast explanation subsystem 118 perturbs each of the lagged variables one by one, until the start of the time series dataset and generates a permuted prediction for time T to obtain the respective influence of the data point on the forecast time T. In other words, while perturbing to observe the effect of a specific lagged variable, the value of the specific lagged variable is perturbed while keeping all other lagged values constant.

At block 216, the forecast explanation subsystem 118 aggregates the explanation information generated for each data point in the time series dataset at block 214 to generate explanation information for the time series dataset that includes explanation information generated for each data point in the time series dataset.

At block 218, the forecast explanation subsystem 118 outputs the actual forecast and the explanation information for the time series dataset. In certain examples, the processing performed at block 218 may include communicating the actual forecast and the explanation information for the time series dataset to a user associated with the source (102).

While the embodiment depicted in FIG. 2 describes that the forecast explanation subsystem 118 performs the processing described in blocks 210-214 for each data point in the times series dataset to generate explanation information for each data point (i.e., all the data points) in the time series dataset, in certain alternative embodiments, the forecast explanation subsystem 118 may be configured to perform the processing described in blocks 210-214 for only a subset of the data points in the time series dataset. The subset of data points may be specified as part of the forecast request 104 or may be pre-determined by an administrator of the system 120. In this situation, the forecast explanation subsystem 118 may generate explanation information for only the subset of data points, where the explanation information comprises information indicative of an impact of the subset of data points in the time series dataset on the actual forecast 114.

FIG. 3 depicts an example of a process 300 by which the time series forecasting service system 120 shown in FIG. 1 generates explanation information for a data point, according to certain embodiments. The processing depicted in FIG. 3 describes additional details of the processing performed by the forecast explanation subsystem 118 in block 214 of FIG. 2 to generate explanation information for a data point in the time series dataset. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 300 presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order or some steps may also be performed in parallel.

In certain embodiments, as part of the processing performed to generate explanation information for a data point in the time series dataset, at block 310, the forecast explanation subsystem 118 computes a feature forecast weight for the data point based upon the permuted prediction obtained in 212, the actual forecast obtained in 206, the permuted value of the data point obtained in 210 and the actual value of the data point. In a certain implementation, the feature forecast weight for the data point is computed as a ratio of the difference between the permuted prediction and the actual prediction to the difference between the permuted value for the data point and the actual value of the data point as shown in equation (1) below:

$$\begin{matrix}F o r e c a s t f e a t u r e w e i g h t f o r \text{} {Y}_{t - 1} = \\ \frac{P e r m u t e d P r e d i c t i o {n}_{t} - A c t u a l P r e d i c t i o {n}_{t}}{p e r m u t e d l a g g e d v a l u {e}_{t - 1} - A c t u a l l a g g e d v a l u {e}_{t - 1}}\end{matrix}$$

Where: Actual Prediction is the prediction generated for a future time point t without any perturbations; Permuted Prediction is the prediction generated for the time point t using the perturbed value for data point (t-1) while keeping all the other data points the same (i.e., not perturbed); Permuted lagged value is the value of data point (t-1) as a result of the perturbation; and Actual lagged value is the value of the data point (t-1) without any perturbation.

In other words, the influence or impact or weight of a historical value/lagged variable at any time step in the past is calculated as the ratio of the difference of forecasts with and without perturbation to the difference of the actual value of the lagged target variable and perturbed value of the lagged target variable.

At block 312, the forecast explanation subsystem 118 computes a forecast feature importance (FFI) value for the data point using the feature forecast weight computed for the data point in block 310. In a certain implementation, the forecast feature importance (FFI) value for the data point is computed as a product of a first term and a second term, where the first term comprises the feature forecast weight computed for the data point and the second term is computed by computing a difference between the actual value of the data point and the mean of the data points in the time series dataset as shown in equation (2) below:

$$\begin{matrix}F o r e c a s t f e a t u r e I m p o r t a n c e f o r {Y}_{t - 1} = \\ F o r e c a s t f e a t u r e w e i g h t f o r {Y}_{t - 1} * \\ \left(F e a t u r e v a l u e o f {Y}_{t - 1} - F e a t u r e M e a n o f {Y}_{t - 1}\right)\end{matrix}$$

Where: Forecast feature weight is the forecast feature weight value generated for the data point (t-1); Feature value is the actual value of the data point (t-1); Feature Mean of the data point is derived by computing the mean of all the values in the time series dataset [y₀, y₁, y₂, ... , yₜ₋₁]

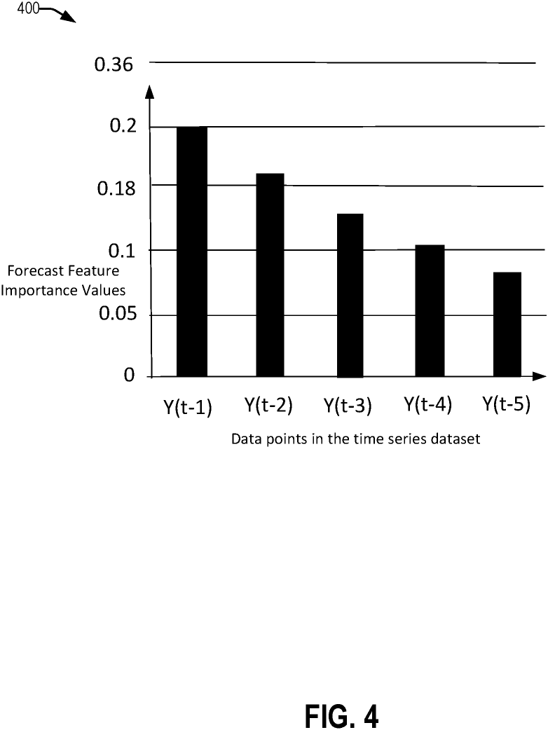

The forecast feature importance values for the data points represent the explanation information for the actual forecast (actual prediction). The actual forecast along with explanation information comprising information indicative of one or more the forecast feature importance values may then be output by the forecast explanation subsystem 118 to a user of the source 102. In a certain implementation, the explanation information for the time series dataset may be represented as a visualization comprising a bar graph as shown in FIG. 4, where the bar graph represents the impact of the actual value of the one or more data points on the actual forecast.

FIG. 4 is an exemplary illustration of the representation of explanation information for a time series dataset, according to certain embodiments. In the example depicted in FIG. 4, the explanation information is represented as a bar graph 400 that shows the forecast feature importance values (i.e., impact of the actual values) along the Y axis of the lag data points in the time series dataset depicted along the X axis on the predicted forecast. For example, in the visualization shown in FIG. 4, the data point y(t-1) has a higher impact (higher forecast feature importance value, 0.2) than data point y(t-2) (having a forecast feature importance value slightly over 0.18), which in turn has a higher impact than data point y(t-3) (having a forecast feature importance value between 0.1 and 0.18) and so on. While the embodiment depicted in FIG. 2 represents a visualization of the explanation information for a time series dataset in the form of a bar chart, in other embodiments, various other types of visualizations may be used to represent the explanation information such as, a segmented bar graph, a pie chart, a column graph and so on.

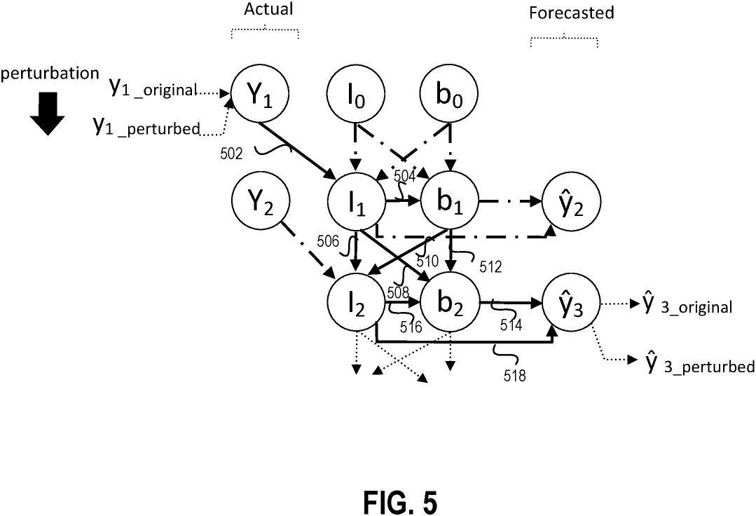

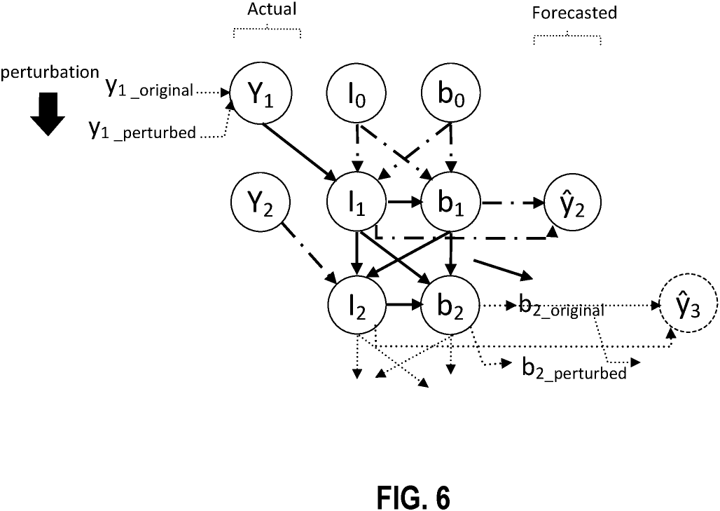

As described herein, a novel empirical technique is disclosed that can be used to explain the predictions from statistical models. In certain embodiments, and as described in FIG. 5 and FIG. 6 below, the techniques described herein can be used to explain the predictions from any linear statistical model, from simple models, such as Simple Moving Average models, Simple Exponential Smoothing models, to more complex models, such as Double/Triple Exponential Smoothing models, ARIMA models, and others.

FIG. 5 depicts an example of a forecast generated using a Holt’s Linear Trend statistical model for a time series dataset, according to certain embodiments. The Holt-Winters Trend statistical model is a model used for forecasting the behavior of a sequence of time series values over time. The Holt’s model is also referred to as a double exponential smoothing model or a trend-enhanced exponential smoothing model and uses two parameters, one for the overall smoothing and the other for the trend smoothing equation. The Holt’s model is composed of three separate equations (a) (b) and (c) shown below that work together to generate a final forecast. The first equation (a) is a basic smoothing equation that directly adjusts the last smoothed value for last period’s trend. The trend itself is updated over time through the second equation (b), where the trend is expressed as the difference between the last two smoothed values. Finally, the third equation (c) is used to generate the final forecast.

$$\text{Level} \text{equation} , {l}_{\text{t}} = {\text{ay}}_{\text{t}} \text{+} \left(1 - \text{a}\right) \left({l}_{\text{t} - 1} + {\text{b}}_{\text{t} - \text{1}}\right)$$

$$\text{Trend} \text{equation} , {\text{b}}_{\text{t}} = β ∗ \left({l}_{\text{t}} - {l}_{\text{t} - 1}\right) + \left(1 - β ∗\right) {\text{b}}_{\text{t} - \text{1}}$$

$$\text{Forecast} \text{equation,} {\hat{\text{y}}}_{\text{t}} + \text{h} \left|{}_{\text{t}} = {l}_{\text{t}} {\text{+hb}}_{\text{t}}\right)$$

where ft denotes an estimate of the level of the times series dataset at time t, H denotes the h^{th} step of the forecast horizon, bt denotes an estimate of the trend (slope) of the times series dataset at time t, α is the smoothing parameter for the level and β* is the smoothing parameter for the trend.

The expanded form of the Holt’s Linear Trend method depicted in FIG. 5. The impact or weight of y₁ on the predicted forecast ŷ₃ is the culmination of all the linear paths (502, 504, 506, 510, 512, 514, 516, and 518)and is represented using equation (d) below:

$${\hat{\text{y}}}_{3} = \left(\text{some weight}\right) * {\text{y}}_{1} + Σ \left(\text{other lagged features}\right) * \left(\text{their weights}\right)$$

Expanding the set of equations (a) (b) and (c) recursively for each time step can become complicated when the contribution of each of the y’s (actual lag features) on the ŷ’s (forecast values) have to be calculated. Instead of calculating this culmination (some weight) manually, by using the disclosed technique, the input y₁ can be perturbed by some value and passed to the model which, in turn, does all the traversing of the paths (502, 504, 506, 510, 512, 514, 516, and 518) internally to generate the perturbed value ŷ₃. So, when the ratio of the difference between the original (y₁, ŷ₃) and perturbed (y₁, ŷ₃) is determined, the ‘some weight’ value represented in equation (d) can be isolated.

Since the equations for Holt’s Linear Trend, it’s other complex variations and ARIMA, and other linear statistical models are all linear, the slope or weight is constant for any perturbation and hence any perturbation amount can be applied using the disclosed technique. Thus, the disclosed perturbation technique can be applied to any linear statistical model, simple or complicated, with any perturbation value. For an ARIMA statistical model, this method is specifically useful when we have MA(q) terms and the forecast is also based on the past error terms. The error terms are related to the previous lagged variables but deriving that relationship is complicated. By using the innovative approach described in this disclosure, the weights that quantify the influence of past values on the forecast can be obtained, including the way they interact through the error terms. Additionally, the disclosed innovative approach can be used to derive feature weights for linear statistical models, without the need to derive the complex underlying formula (or formulae).

In certain cases, exponential smoothing models, depending on the type of model can have intermediate components like level, trend and seasonality components. For example, as depicted in FIG. 5, the double exponential smoothing model, also known as the Holt’s Linear Trend model, has level and trend components calculated before the final forecast. FIG. 6 depicts the expansion representation form of the Holt’s Linear Trend method, according to certain embodiments. The innovative empirical approach described in this disclosure can also be used to explain these intermediate components in terms of the lagged variables. A similar approach is followed to observe specific values for these components while the lagged values of the time series are perturbed. In certain embodiments, the following equations (e), (f) and (g) can be used to arrive at feature importance of lagged variables vis a vis level, trend and seasonality components:

$$\begin{matrix}L e v e l F e a t u r e s I m p o r t a n c e o f {l}_{t - 1} = \\ {\frac{P e r m u t e d l e v e l v a l u {e}_{t} - A c t u a l l e v e l v a l u {e}_{t}}{P e r m u t e d l a g g e d v a l u {e}_{t - 1} - A c t u a l l a g g e d v a l u e}}_{t - 1}\end{matrix}$$

$$\begin{matrix}T r e n d F e a t u r e i m p o r t a n c e \text{} o f {b}_{t - 1} = \\ \frac{P e r m u t e d t r e n d v a l u {e}_{t} - A c t u a l t r e n d v a l u {e}_{t}}{P e r m u t e d l a g g e d \text{} v a l u {e}_{t - 1} - A c t u a l l a g g e d v a l u {e}_{t - 1}}\end{matrix}$$

$$\begin{matrix}S e a s o n a l i t y F e a t u r e I m p o r t a n c e o f \text{} {s}_{t - 1} = \\ \frac{P e r m u t e d s e a s o n a l i t y v a l u {e}_{t} - A c t u a l s e a s o n a l i t y v a l u {e}_{t}}{P e r m u t e d l a g g e d v a l u {e}_{t - 1} - A c t u a l l a g g e d v a l u {e}_{t - 1}}\end{matrix}$$

This demonstrates the general applicability of the disclosed perturbation method to explain any level (if there are any) of a linear statistical model such as the intermediate level of components like level, trend, seasonality or the final level of forecasts.

Additional details related to the processing performed by the time series forecasting service system 120 and the subsystems (e.g., training subsystem 108, forecasting subsystem 112 and forecast explanation subsystem 118) within the time series forecasting service system 120 to generate explanation information for a forecast predicted at a particular time point T is described using the example depicted below. The example shown below illustrates a time series dataset comprising a set of datapoints as shown in table-1. For example, the time series dataset may be received as part of a forecast request by the forecasting subsystem 112 as a result of executing step 202 of FIG. 2. The example shown in table-1 below depicts a quarterly time series dataset comprising fitted values derived using a statistical model (e.g., a triple exponential smoothing model such as the Holt-Winters’ model).

| | | |
|---|---|---|
| Time | Actual Lagged Value (ALV) | Actual Prediction (Actual Forecast) |
| 1999 Q1 | 30.05251 | 30.06358 |
| 1999 Q2 | 19.1485 | 19.15349601 |
| 1999 Q3 | 25.31769 | 25.2162219 |
| 1999 Q4 | 27.59144 | 28.33482797 |
| · | | |
| · | | |
| · | | |
| 2015 Q1 | 73.25703 | 68.76234138 |
| 2015 Q2 | 47.69662 | 47.2895674 |
| 2015 Q3 | 61.09777 | 58.91257401 |
| 2015 Q4 | 66.05576 | 63.86115592 |
| 2016 Q1 | | 75.73768448 |
| | | (Actual Forecast Value) |

Table 1: Quarterly Time Series Dataset comprising data points and fitted values from a triple exponential smoothing model

The Actual Forecast value (75.73768448) depicted in table-1 represents the actual forecast predicted for a future time point T (i.e., 2016 Q1) using the triple exponential smoothing model using the time series dataset. In order to explain the forecast value, each and every lagged variable (lagged data point) in the time series dataset is perturbed and the permuted (perturbed) prediction for the time point T (2016 Q1) is computed. In a certain implementation, each lagged data point may be perturbed by a certain amount (e.g., 1, 10 or -1) to generate explanation information for the data point. For instance, for the example shown in table-1, the feature forecast weight can be calculated by plugging in the following values into equation (1) shown above and also reproduced below, when the actual value of a data point (e.g., 2015 Q4) is perturbed by 1. Permuted Predictionₜ = 75.43345536 _{(Perturbed} _{forecast} _{(permuted} _{prediction),} _{when} _{actual value} _{of} _{data} ₚₒᵢₙₜ ₍ₜ₋₁₎ ₂₀₁₅ _{Q4} _{was} _{perturbed} _{by} ₁₎ Actual Predictionₜ = 75.73768448 _{(Actual} _{forecast value} _{for} ₜᵢₘₑ ₚₒᵢₙₜ _{T} ₍₂₀₁₆ _{Q1)} _{from} _{Table} ₁₎ Permuted lagged valueₜ₋₁ = 65.05576 _{(Perturbed} _{lagged value} _{of 2015} _{Q4)} Actual lagged valueₜ₋₁ = 66.05576 _{(Actual} _{lagged} ᵥₐₗᵤₑ _{of 2015} _{Q4)}

$$\begin{matrix}F o r c a s t \text{} f e a t u r e w e i g h t \text{} f o r {Y}_{t - 1} = \\ \left(75.43345536 \text{- 75} \text{.73768448}\right) / \left(65.05576 \text{- 66} \text{.05576}\right) = \\ 0.304229124\end{matrix}$$

The forecast feature weights for all the lagged data points in the time series dataset (e.g., 1999 Q1....2015 Q3) may be similarly computed. The feature forecast importance value for a data point (e.g., 2015 Q4) can be calculated by plugging in the following values into equation (2) shown above and reproduced below, when perturbed by 1. Forecast feature weight for yₜ₋₁ = 0.304229124 Feature value of yₜ₋₁ = 66.05576 Mean of y - 1 = 40.93265191

$$\begin{matrix}F o r e c a s t f e a t u r e I m p o r t a n c e f o r {y}_{t - 1} = \\ 0.304229124 ∗ \left(66.05576 \text{- 40} \text{.93265191}\right) = 7.643181\end{matrix}$$

Table-2 shown below illustrates the forecast feature importance values computed for all the lagged data points in the time series dataset (e.g., 1999 Q1....2015 Q3) for the actual forecast at time point, (2016 Q1):

TABLE 2

Forecast Feature Importance Values of the data points on the actual forecast at time point T (2016 Q1) from a triple exponential smoothing model

| Feature | Feature Importance for First Step Forecast |
|---|---|
| Y(t-67) | 5.06E-05 |
| Y(t-66) | 0.000216648 |
| Y(t-65) | -0.000198833 |
| · | |
| · | |
| Y(t-3) | 16.73897371 |
| Y(t-2) | 0.996173141 |
| Y(t-1) | 7.643191091 |

While the above example describes explanation information generated using a triple exponential smoothing model for a forecast predicted at a future time point T (i.e., 2016 Q1), in other embodiments, the model can also be used to generate explanation information for multiple forecasts predicted at multiple future time points such as (2016 Q2), (2016 Q3), (2016 Q4) and so on.

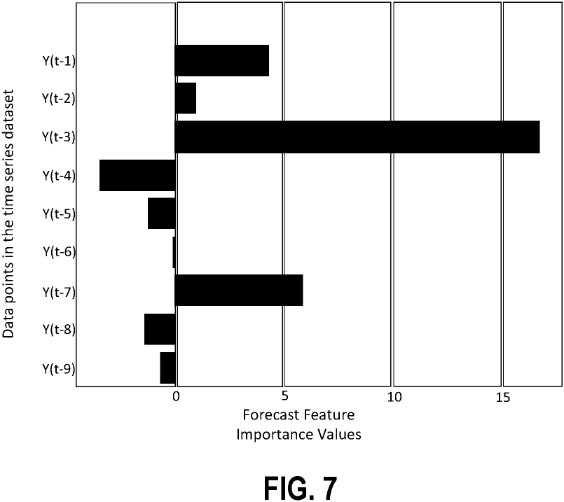

As previously described, in a certain implementation, the explanation information (for e.g., the forecast feature importance values) may be represented as a bar graph that shows the forecast feature importance values (i.e., impact of the actual values) along the X axis and the lag data points in the time series dataset depicted along the Y axis on the predicted forecast at time point T. FIG. 7 illustrates a visual representation of the forecast feature importance values computed using a triple exponential smoothing model for a future time point based on a time series dataset, according to certain embodiments. The depicted example is a visual representation of the forecast feature importance values computed using the triple exponential smoothing model for a future time point T based on a time series dataset shown in table-1. In the visualization shown in FIG. 7, the data point y(t-1) has a higher impact than the data point y(t-2). However, the data point y(t-3) has a higher impact than both the data points y(t-2) and (y-1) indicating a strong seasonality impact on the predicted forecast. Further, it may be observed that some of the data points (e.g., y(t-6), y(y-9)) in the time series dataset have little or no impact on the predicted forecast. The visual representation of the importance of the data points in the time series dataset thus enables a user to have some visibility into why a particular forecast was predicted by the statistical model.

In certain embodiments, to validate the robustness of the innovative technique described herein, for some models, the feature weights obtained using the innovative approach were compared with the actual derived equation for relationship between forecast and lagged variables where it was manually possible. For a single exponential smoothing model, it was observed that the coefficients for each lagged variable decreased exponentially with time and can be calculated as shown below:

$$C o e f f i c i e n t o f \text{} {Y}_{t - j} = α ∗ {\left(1 - α\right)}^{j - 1}$$

The feature weights that are obtained using the innovative empirical approach were determined to match the coefficients that were obtained by deriving the relationship manually as shown above for a single exponential smoothing model. In a specific implementation, for a simple exponential smoothing model with α = 0.6, the forecast feature weights from the empirical approach were compared to the weights derived manually and both these values were found to match. In this specific example, using the empirical approach, the forecast feature weights for the last 5 lagged values [y(t-1), y(t-2), y(t-3), y(t-4), y(t-5)] was determined to be [0.6, 0.24, 0.096, 0.0384., 0.01536] and the forecast feature weights for the last 5 lagged values using the manual approach was determined to be [0.6, 0.24, 0.096, 0.0384., 0.01536]. Similarly, the empirical approach of calculating feature weights with manually deriving coefficients for lagged variables of MA(q) models, and ARIMA model were validated and the weights were found to match.

In certain embodiments, the time series prediction functionality may be offered as a cloud service by a cloud services provider (CSP). The functionality to provide explanations for the predictions, as described in this disclosure, may also be offered as part of the service. A customer can subscribe to the service and can then submit requests for time series forecasts. The service will generate the forecasts and send them to the requesting subscriber. As part of generating the forecast, the service may also generate explanations for the predicted forecasts as described in this disclosure. The explanations may also be communicated to the requesting subscriber along with the predicted forecasts.

In certain embodiments, the time series forecasting and prediction explanation functionality may be provided as a service by an Infrastructure-as-a-Service (IaaS) provider. The following section describes an example IaaS infrastructure that may be used to implement the service.

### EXAMPLE IAAS INFRASTRUCTURE

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider’s services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider’s services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

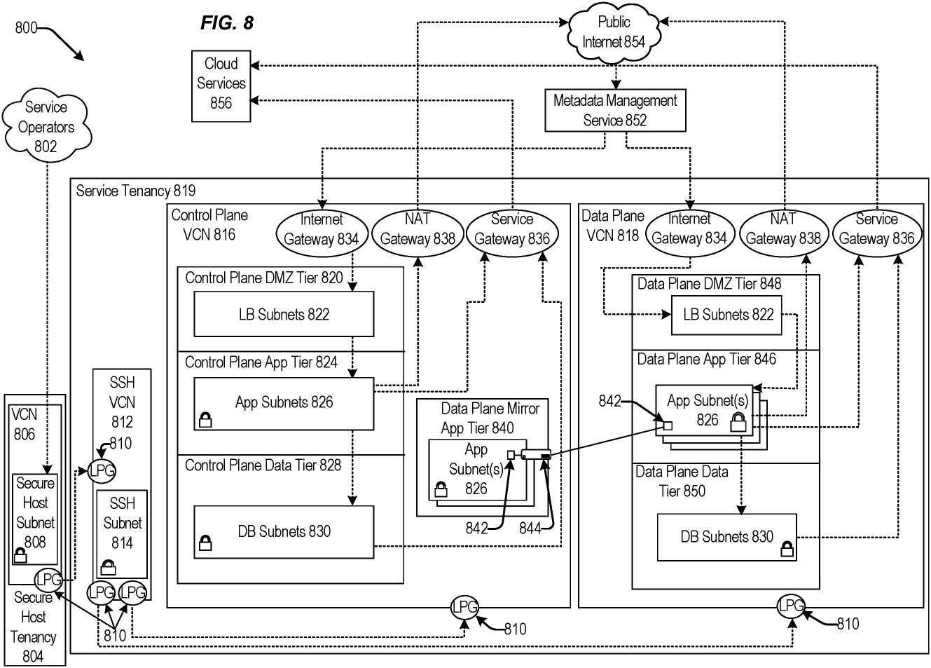

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Memory that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users’, or other customers’, resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

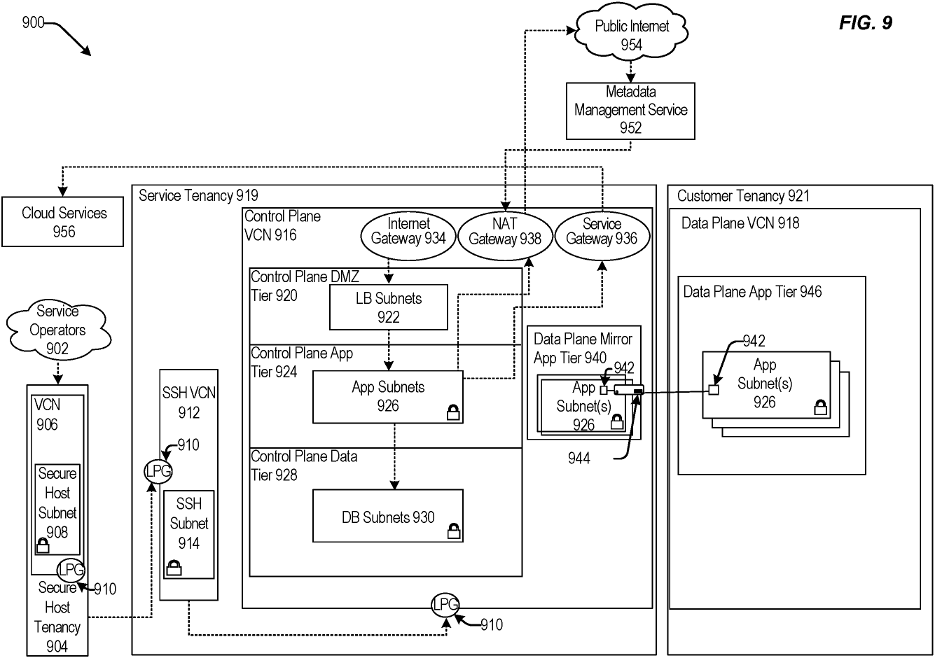

FIG. 9 is a block diagram 900 illustrating another example pattern of an IaaS architecture, according to at least one embodiment. Service operators 902 (e.g. service operators 802 of FIG. 8) can be communicatively coupled to a secure host tenancy 904 (e.g. the secure host tenancy 804 of FIG. 8) that can include a virtual cloud network (VCN) 906 (e.g. the VCN 806 of FIG. 8) and a secure host subnet 908 (e.g. the secure host subnet 808 of FIG. 8). The VCN 906 can include a local peering gateway (LPG) 910 (e.g. the LPG 810 of FIG. 8) that can be communicatively coupled to a secure shell (SSH) VCN 912 (e.g. the SSH VCN 812 of FIG. 8) via an LPG 810 contained in the SSH VCN 912. The SSH VCN 912 can include an SSH subnet 914 (e.g. the SSH subnet 814 of FIG. 8), and the SSH VCN 912 can be communicatively coupled to a control plane VCN 916 (e.g. the control plane VCN 816 of FIG. 8) via an LPG 910 contained in the control plane VCN 916. The control plane VCN 916 can be contained in a service tenancy 919 (e.g. the service tenancy 819 of FIG. 8), and the data plane VCN 918 (e.g. the data plane VCN 818 of FIG. 8) can be contained in a customer tenancy 921 that may be owned or operated by users, or customers, of the system.

The control plane VCN 916 can include a control plane DMZ tier 920 (e.g. the control plane DMZ tier 820 of FIG. 8) that can include LB subnet(s) 922 (e.g. LB subnet(s) 822 of FIG. 8), a control plane app tier 924 (e.g. the control plane app tier 824 of FIG. 8) that can include app subnet(s) 926 (e.g. app subnet(s) 826 of FIG. 8), a control plane data tier 928 (e.g. the control plane data tier 828 of FIG. 8) that can include database (DB) subnet(s) 930 (e.g. similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g. the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g. the service gateway of FIG. 8) and a network address translation (NAT) gateway 938 (e.g. the NAT gateway 838 of FIG. 8). The control plane VCN 916 can include the service gateway 936 and the NAT gateway 938.

The control plane VCN 916 can include a data plane mirror app tier 940 (e.g. the data plane mirror app tier 840 of FIG. 8) that can include app subnet(s) 926. The app subnet(s) 926 contained in the data plane mirror app tier 940 can include a virtual network interface controller (VNIC) 942 (e.g. the VNIC of 842) that can execute a compute instance 944 (e.g. similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g. the metadata management service 852 of FIG. 8) that can be communicatively coupled to public Internet 954 (e.g. public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g. cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 5,” may be located in Region 1 and in “Region 2.” If a call to Deployment 5 is made by the service gateway 936 contained in the control plane VCN 916 located in Region 1, the call may be transmitted to Deployment 5 in Region 1. In this example, the control plane VCN 916, or Deployment 5 in Region 1, may not be communicatively coupled to, or otherwise in communication with, Deployment 5 in Region 2.

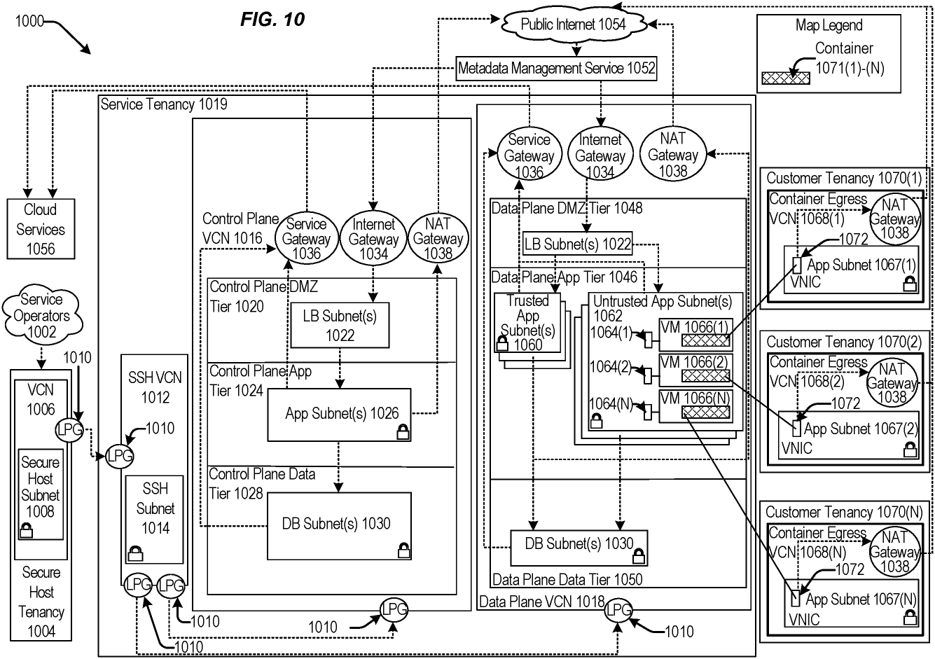

FIG. 10 is a block diagram 1000 illustrating another example pattern of an IaaS architecture, according to at least one embodiment. Service operators 1002 (e.g. service operators 502 of FIG. 5) can be communicatively coupled to a secure host tenancy 1004 (e.g. the secure host tenancy 504 of FIG. 5) that can include a virtual cloud network (VCN) 1006 (e.g. the VCN 806 of FIG. 8) and a secure host subnet 1008 (e.g. the secure host subnet 808 of FIG. 8). The VCN 1006 can include an LPG 1010 (e.g. the LPG 810 of FIG. 8) that can be communicatively coupled to an SSH VCN 1012 (e.g. the SSH VCN 812 of FIG. 8) via an LPG 1010 contained in the SSH VCN 1012. The SSH VCN 1012 can include an SSH subnet 1014 (e.g. the SSH subnet 814 of FIG. 8), and the SSH VCN 1012 can be communicatively coupled to a control plane VCN 1016 (e.g. the control plane VCN 816 of FIG. 8) via an LPG 1010 contained in the control plane VCN 1016 and to a data plane VCN 1018 (e.g. the data plane 818 of FIG. 8) via an LPG 1010 contained in the data plane VCN 1018. The control plane VCN 1016 and the data plane VCN 1018 can be contained in a service tenancy 1019 (e.g. the service tenancy 819 of FIG. 8).

The control plane VCN 1016 can include a control plane DMZ tier 1020 (e.g. the control plane DMZ tier 820 of FIG. 8) that can include load balancer (LB) subnet(s) 1022 (e.g. LB subnet(s) 822 of FIG. 8), a control plane app tier 1024 (e.g. the control plane app tier 824 of FIG. 8) that can include app subnet(s) 1026 (e.g. similar to app subnet(s) 826 of FIG. 8), a control plane data tier 1028 (e.g. the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g. the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g. the service gateway of FIG. 8) and a network address translation (NAT) gateway 1038 (e.g. the NAT gateway 838 of FIG. 8). The control plane VCN 1016 can include the service gateway 1036 and the NAT gateway 1038.

The data plane VCN 1018 can include a data plane app tier 1046 (e.g. the data plane app tier 846 of FIG. 8), a data plane DMZ tier 1048 (e.g. the data plane DMZ tier 848 of FIG. 8), and a data plane data tier 1050 (e.g. the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g. public Internet 854 of FIG. 8).

The Internet gateway 1034 contained in the control plane VCN 1016 and contained in the data plane VCN 1018 can be communicatively coupled to a metadata management service 1052 (e.g. the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

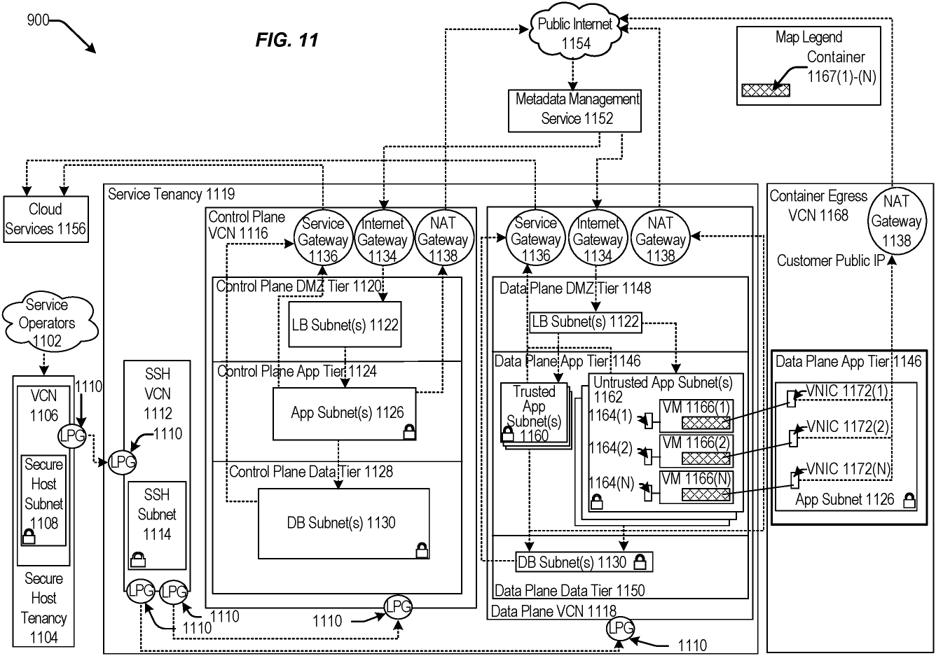

FIG. 11 is a block diagram 1100 illustrating another example pattern of an IaaS architecture, according to at least one embodiment. Service operators 1102 (e.g. service operators 802 of FIG. 8) can be communicatively coupled to a secure host tenancy 804 (e.g. the secure host tenancy 804 of FIG. 8) that can include a virtual cloud network (VCN) 1106 (e.g. the VCN 806 of FIG. 8) and a secure host subnet 1108 (e.g. the secure host subnet 808 of FIG. 8). The VCN 1106 can include an LPG 1110 (e.g. the LPG 810 of FIG. 8) that can be communicatively coupled to an SSH VCN 1112 (e.g. the SSH VCN 812 of FIG. 8) via an LPG 1110 contained in the SSH VCN 1112. The SSH VCN 1112 can include an SSH subnet 1114 (e.g. the SSH subnet 814 of FIG. 8), and the SSH VCN 1112 can be communicatively coupled to a control plane VCN 1116 (e.g. the control plane VCN 816 of FIG. 8) via an LPG 1110 contained in the control plane VCN 1116 and to a data plane VCN 1118 (e.g. the data plane 818 of FIG. 8) via an LPG 1110 contained in the data plane VCN 1118. The control plane VCN 1116 and the data plane VCN 1118 can be contained in a service tenancy 1119 (e.g. the service tenancy 819 of FIG. 8).

The control plane VCN 1116 can include a control plane DMZ tier 1120 (e.g. the control plane DMZ tier 820 of FIG. 8) that can include LB subnet(s) 1122 (e.g. LB subnet(s) 822 of FIG. 8), a control plane app tier 1124 (e.g. the control plane app tier 824 of FIG. 8) that can include app subnet(s) 1126 (e.g. app subnet(s) 826 of FIG. 8), a control plane data tier 1128 (e.g. the control plane data tier 828 of FIG. 8) that can include DB subnet(s) 1130 (e.g. DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g. the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g. the service gateway of FIG. 8) and a network address translation (NAT) gateway 1138 (e.g. the NAT gateway 838 of FIG. 8). The control plane VCN 1116 can include the service gateway 1136 and the NAT gateway 1138.

The data plane VCN 1118 can include a data plane app tier 1146 (e.g. the data plane app tier 846 of FIG. 8), a data plane DMZ tier 1148 (e.g. the data plane DMZ tier 848 of FIG. 8), and a data plane data tier 1150 (e.g. the data plane data tier 850 of FIG. 8). The data plane DMZ tier 1148 can include LB subnet(s) 1122 that can be communicatively coupled to trusted app subnet(s) 1160 (e.g. trusted app subnet(s) 1060 of FIG. 10) and untrusted app subnet(s) 1162 (e.g. untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g. public Internet 854 of FIG. 8).

The Internet gateway 1134 contained in the control plane VCN 1116 and contained in the data plane VCN 1118 can be communicatively coupled to a metadata management service 1152 (e.g. the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 800 of FIG. 8 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 1100, 600, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

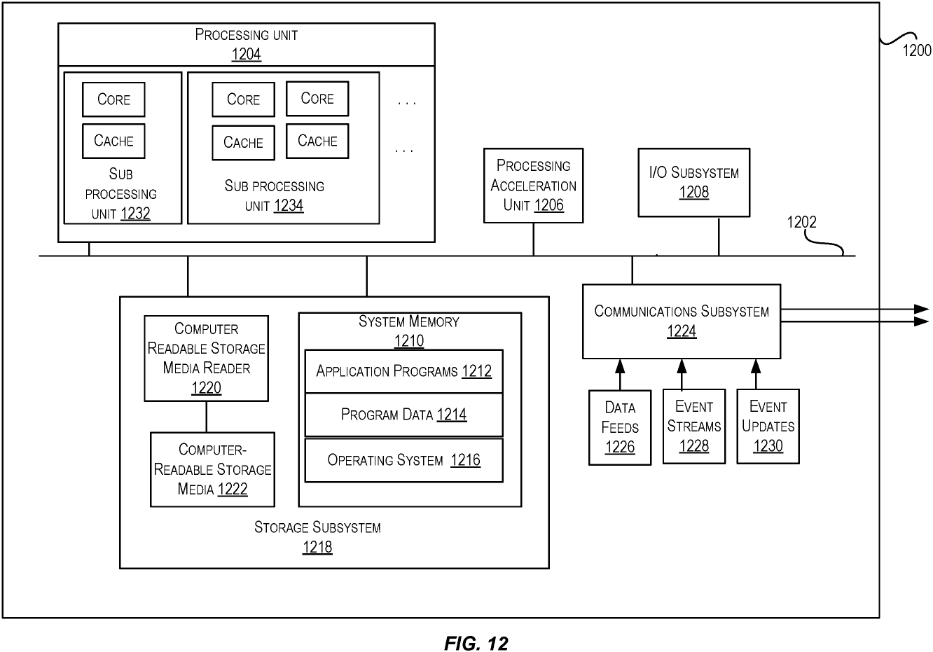

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 9 OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present disclosure.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
responsive to an actual forecast predicted for a particular time point using a trained model, wherein the trained model is generated by training a time series dataset comprising a plurality of data points, each data point in the time series dataset having an actual value and an associated time value:
for each data point in one or more data points in the time series dataset:
perturbing the actual value of a data point by a certain amount to generate a permuted value for the data point;
using the trained model to predict a permuted prediction for the particular time point based on the permuted value for the data point and the actual values for the other data points in the times series dataset other than the data point; and
generating explanation information for the data point based on the permuted prediction for the particular time point, the actual forecast, the permuted value for the data point and the actual value of the data point;
generating explanation information for the time series dataset, wherein the explanation information includes the explanation information generated for the one or more data points in the time series dataset; and
outputting the actual forecast and the explanation information for the time series dataset.

2. The computer-implemented method of claim 1, wherein the explanation information for the time series dataset is indicative of an impact of the actual value of each data point in the one or more data points on the actual forecast.

3. The computer-implemented method of claim 1, wherein the time series dataset is received from a forecast request from a source, and wherein the outputting comprises communicating the actual forecast and the explanation information for the time series dataset to the source.

4. The computer-implemented method of claim 1, wherein generating the explanation information for the data point comprises:
computing a feature forecast weight for the data point based upon the permuted prediction for the particular time point, the actual forecast, the permuted value for the data point and the actual value of the data point;
computing a forecast feature importance value for the data point using the feature forecast weight computed for the data point.

5. The computer-implemented method of claim 4, wherein the feature forecast weight for the data point is computed as a ratio of the difference between the permuted prediction and the actual prediction to the difference between the permuted value for the data point and the actual value of the data point.

6. The computer-implemented method of claim 4, wherein the forecast feature importance value for the data point is computed as a product of a first term and a second term, wherein the first term comprises the feature forecast weight computed for the data point and the second term is computed by computing a difference between the actual value of the data point and the mean of the one or more data points in the time series dataset.

7. The computer-implemented method of claim 4, further comprising outputting the actual forecast along with the forecast feature importance value computed for the data point.

8. The computer-implemented method of claim 1, wherein the explanation information for the time series dataset is represented as a visualization comprising a bar graph, wherein the bar graph represents the impact of the actual value of each data point in the one or more data points on the actual forecast.

9. The computer-implemented method of claim 8, wherein outputting the actual forecast and the explanation information for the time series dataset to the source comprises outputting the bar graph to the source.

10. The computer-implemented method of claim 8, wherein the model is a statistical model comprising at least one of an exponential smoothing model or an Autoregressive Integrated Moving Average (ARIMA) model.

11. A system comprising:
a memory; and
one or more processors configured to perform processing comprising:
responsive to an actual forecast predicted for a particular time point using a trained model, wherein the trained model is generated by training a time series dataset comprising a plurality of data points, each data point in the time series dataset having an actual value and an associated time value:
for each data point in one or more data points in the time series dataset:
perturbing the actual value of a data point by a certain amount to generate a permuted value for the data point;
using the trained model to predict a permuted prediction for the particular time point based on the permuted value for the data point and the actual values for the other data points in the times series dataset other than the data point; and
generating explanation information for the data point based on the permuted prediction for the particular time point, the actual forecast, the permuted value for the data point and the actual value of the data point;
generating explanation information for the time series dataset, wherein the explanation information includes the explanation information generated for the one or more data points in the time series dataset; and
outputting the actual forecast and the explanation information for the time series dataset.

12. The system of claim 11, wherein the explanation information for the time series dataset is indicative of an impact of the actual value of each data point in the one or more data points on the actual forecast.

13. The system of claim 11, wherein generating the explanation information for the data point comprises:
computing a feature forecast weight for the data point based upon the permuted prediction for the particular time point, the actual forecast, the permuted value for the data point and the actual value of the data point;
computing a forecast feature importance value for the data point using the feature forecast weight computed for the data point.

14. The system of claim 13, wherein the feature forecast weight for the data point is computed as a ratio of the difference between the permuted prediction and the actual prediction to the difference between the permuted value for the data point and the actual value of the data point.

15. The system of claim 13, wherein the forecast feature importance value for the data point is computed as a product of a first term and a second term, wherein the first term comprises the feature forecast weight computed for the data point and the second term is computed by computing a difference between the actual value of the data point and the mean of the one or more data points in the time series dataset.

16. The system of claim 13, further comprising outputting the actual forecast along with the forecast feature importance value computed for the data point.

17. The system of claim 11, wherein the explanation information for the time series dataset is represented as a visualization comprising a bar graph, wherein the bar graph represents the impact of the actual value of each data point in the one or more data points on the actual forecast.

18. A non-transitory computer-readable medium having program code that is stored thereon, the program code executable by one or more processing devices for performing operations comprising:
responsive to an actual forecast predicted for a particular time point using a trained model, wherein the trained model is generated by training a time series dataset comprising a plurality of data points, each data point in the time series dataset having an actual value and an associated time value:
for each data point in one or more data points in the time series dataset:
perturbing the actual value of a data point by a certain amount to generate a permuted value for the data point;
using the trained model to predict a permuted prediction for the particular time point based on the permuted value for the data point and the actual values for the other data points in the times series dataset other than the data point; and
generating explanation information for the data point based on the permuted prediction for the particular time point, the actual forecast, the permuted value for the data point and the actual value of the data point;
generating explanation information for the time series dataset, wherein the explanation information includes the explanation information generated for the one or more data points in the time series dataset; and
outputting the actual forecast and the explanation information for the time series dataset.

19. The non-transitory computer-readable medium of claim 18, wherein the explanation information for the time series dataset is indicative of an impact of the actual value of each data point in the one or more data points on the actual forecast.

20. The non-transitory computer-readable medium of claim 18, wherein the time series dataset is received from a forecast request from a source, and wherein the outputting comprises communicating the actual forecast and the explanation information for the time series dataset to the source.
